(19) United States
(12) Patent Application Publication
(10) Pub. No.: US 2020/0361700 A1
(43) Pub. Date: Nov. 19, 2020

(54) INDUSTRIAL CONSUMABLES STORAGE AND DETECTION STAND AND METHOD

(71) Applicant: Raptor Mining Products, Inc., Edmonton (CA)

(72) Inventors: Craig Harder, Edmonton (CA); Paul Weber, Edmonton (CA); Michael Thompson, Edmonton (CA)

(21) Appl. No.: 15/930,496

(22) Filed: May 13, 2020

Related U.S. Application Data
(60) Provisional application No. 62/847,361, filed on May 14, 2019.

(51) Int. Cl. B65D 85/68; B65D 19/00; B65D 19/44; G06K 19/07

(52) U.S. Cl. CPC B65D 85/68; B65D 19/0093; B65D 19/44; G06K 19/0723; B65D 2519/00815; B65D 2519/00293; B65D 2519/00323; B65D 2519/00328; B65D 2519/00273

(57) ABSTRACT

This invention relates generally to a stand for holding industrial consumables, and more specifically to a stand with sensors for detecting the presence or absence of industrial consumables fitted with identification tags and for wirelessly transmitting that information to a computer. Such a stand is used in such industries as construction and mining. In mining, the stand is for holding mining consumables, and more specifically is a stand comprising a wireless transmitter and one or more radio-frequency identification (RFID) readers capable of detecting mining consumables with RFID tags placed on the stand. The invention also relates to a method of monitoring industrial consumables using a stand with a wireless transmitter and at least one RFID reader wherein the industrial consumables have RFID tags, and the presence or absence of industrial consumables is relayed to a computer.

### FIELD OF THE INVENTION

The present invention relates generally to a stand for storing industrial consumables, and more specifically to a stand, such as a mining stand, with sensors for detecting the presence of industrial consumables fitted with identification tags and for wirelessly transmitting the information regarding the presence or absence of industrial consumables to a computer or smart device.

### BACKGROUND OF THE INVENTION

There are many different types of consumables for various industries, but generally these are the equipment and tools that are consumed or subsumed into other machines and equipment in industrial processes. For example, one type of industrial consumable used in construction or the mining industry are ripper tips for bulldozers. During use, mining and construction consumables are typically subjected to a significant amount of wear and tear. As such, those consumables frequently require maintenance services, repair or replacement and a sufficient number of consumables are needed on site to allow the mining or construction process to continue with minimal downtime in order to maximize profitability. Industrial consumables should be stored in an accessible mode for easy access for when they are needed and they need to be replenished on the job site rapidly to avoid work downtime.

In the construction and mining industry, consumables are supplied as needed and sometimes stored on stands for easy access, and then re-stocked. For example, Canadian patent application no. 2,820,064 describes a stand for supporting a moldboard and a drawbar of a grading machine, for use in construction and mining.

Currently there are various methods used to keep track of inventory stored in buildings, such as, time intensive manual reviews and check lists as well as computerized systems. Canadian patent no. 2,782,364 entitled Methods and Systems for Tracking Inventory Using an RFID Tag Tape, describes the use of radio-frequency identification (“RFID”) tags affixed with tape onto items of inventory in order to track medical inventory wirelessly using an RFID reader in a healthcare facility. This system can also be used for mail storage facilities and inventory storage in a store.

Such RFID inventory tracking is not used in the mining industry. At a mine site, the only way for the mining office to check how many items are on a stand for consumables is to send somebody in a truck to visually determine how many consumables are present and then report back to the mining office. It is desirable to improve the ease, accuracy and efficiency of keeping a steady and accurate supply of industrial consumables at industrial sites, such as, mining and construction sites, so that consumables are available when needed and time is not lost waiting for replacement consumables. It is also desirable to quickly and efficiently convey the information on the depletion of industrial consumables to the relevant parties, such as, the mining office, the mining company and the manufacture for re-ordering.

### SUMMARY OF THE INVENTION

The present invention is a product and a method relating to stands for supporting industrial consumables with integrated sensors and a transmitter to transmit the information on the presence or absence of consumables fitted with RFID tags.

In an embodiment of this invention there is an industrial consumables storage and detection stand for storing industrial consumables and wirelessly detecting the presence of industrial consumables on the stand and conveying the information on the presence or absence of consumables to a computer or smart device.

In an embodiment of this invention there is a use of the stand of claim 1 at a mining site or construction site.

In an embodiment of this invention there is a stand for supporting and detecting the presence of one or more industrial consumables each affixed with a radio frequency identification (RFID) tag, said stand comprising:
a base frame;
a storage rack;
a wireless transmitter; and
at least one RFID readers.

In an embodiment of this invention there is a use of the stand of claim 3 at a mining site or construction site.

In an embodiment of this invention the stand has four RFID readers.

In an embodiment of this invention there is a method of determining when industrial consumables need to be replenished in which an Industrial Consumables Storage and Detection Stand stores consumables and wirelessly detects the presence of industrial consumables on the stand and conveys the information on the presence or absence of consumables to one or more computers or smart devices.

In an embodiment of the method of this invention, the one or more computers or smart devices are located at one or more of an industrial site, industrial company and industrial consumable manufacturer.

### BRIEF DESCRIPTION OF THE FIGURES

These and other aspects of the present invention will be apparent from the brief description of the drawings and the following detailed description in which:

FIG. 1 is an upper front perspective view of an Industrial Consumables Storage and Detection Stand, according to an embodiment of the present invention.

FIG. 2 is an enlarged view of a portion of the Industrial Consumables Storage and Detection Stand for detecting mining consumables.

### DETAILED DESCRIPTION OF THE INVENTION

The present invention is an Industrial Consumables Storage and Detection Stand for holding, and a method for detecting, industrial consumables for use in industries, such as, mining and construction. The stand has a means for wirelessly detecting the presence of industrial consumables which are fitted with digital data tags, and a wireless transmitter on the stand conveys the presence or absence of the digital data, to a computer or smart device. In an embodiment of the present invention, the stand has an RFID reader to detect the presence (or lack) of individual industrial consumables fitted with RFID tags or smart labels, which consumables may be stored on the stand. In order to remotely monitor the consumables, a wireless transmitter on the stand conveys the digital data receivable at the stand to a computer or smart device in order to monitor the presence or absence of consumables efficiently and accurately. For example, this information can be used: to inform the on-site mining office that a stand needs to be restocked with consumables; to inform a mining company to send more consumables to a mining site; and to directly reorder consumables from their manufacturer.

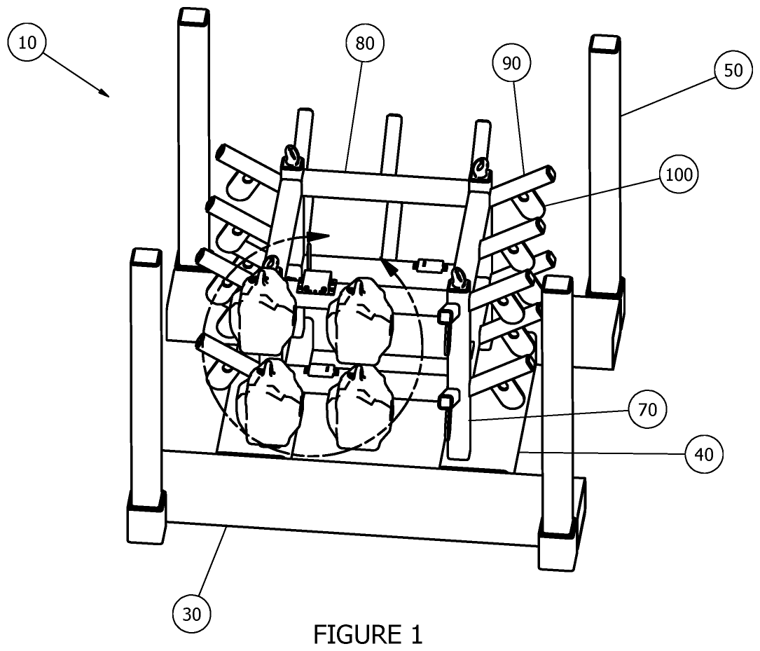

An embodiment of the invention is shown in FIG. 1, in which an Industrial Consumables Storage and Detection Stand 10 for supporting and detecting mining consumables is illustrated. Stand 10 comprises a base and a storage rack. The base is comprised of two parallel long horizontal base beams 30 connected by two parallel short horizontal base beams 40, and this connection may be through welding or other means. Alternatively the base may be a single molded base unit which doesn't tip when industrial consumables are stored on it.

Stand 10 may also include protective vertical beams at the corners or spaced around the perimeter of the base to protect the Industrial Consumables Storage and Detection Stand if bumped by heavy equipment. The protective vertical beams 50 may also stabilize the Industrial Consumables Storage and Detection Stand.

In this embodiment, the storage rack is formed by vertical storage rack beams 70 welded or otherwise connected to the short horizontal base beams 40, and horizontal storage rack beams 80 form rails between the vertical storage rack beams 70. Storage prongs 90 jut out from the horizontal storage rack beams 80 and are capable of holding industrial consumables. In this embodiment storage prong tabs 100 help maintain the consumables on storage prongs 90.

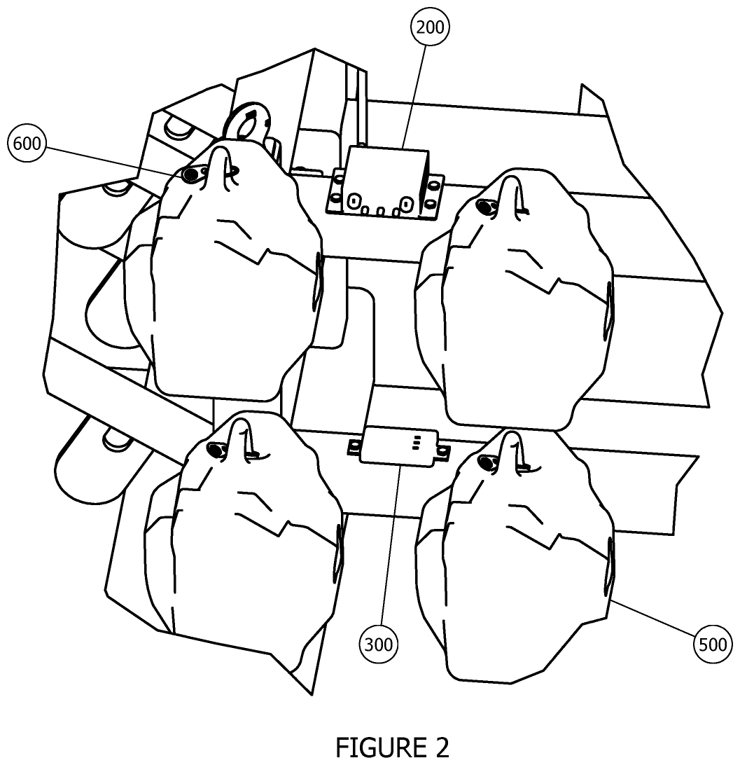

FIG. 2 is an enlarged view of a portion of the storage rack of FIG. 1, which shows more clearly a wireless transmitter 200 and one of the four RFID readers 300 provided in this embodiment. The wireless transmitter 200 and RFID readers 300 may be affixed to the horizontal storage rack beams 80 with a plurality of hexagonal cap screws.

In the embodiment shown in FIGS. 1 and 2, mining ripper tips 500 are stored on storage prongs 90. Each of the ripper tips 500 are affixed (by glue, wire or other means) with an RFID tag 600 which is an integrated circuit and antenna. The RFID tag 600 may be magnetically coupled, electrically coupled, multiple frequency. The tags 600 may also be a smart label or any other system for storing digital data capable of being read.

The RFID readers 300 detect the presence of a tag 600 and send the information wirelessly to the wireless transmitter 200 which sends signals to a computer system or smart device capable of viewing the data. The sensitivity of the RFID readers 300 is set so that they sense consumables on the stand but not consumables being used nearby. The RFID readers 300 have a limited range of a few meters so that when a consumable such as a ripper tip 500 is taken from the stand 10 and used in the field, it will not be sensed.

In a method for detecting industrial consumables on a stand, the absence of detection of a set number of industrial consumables on the stand sends an alert or prompt to the computer or smart device indicating that further consumables need to be sent to the Industrial Consumables Storage and Detection Stand or mining site, or re-ordered. This provides a real-time consumables count at the mining or construction office on site and/or to a remote location, such as the mining company and/or a manufacturer of the consumables.

The invention provides for relaying the information on the depletion of consumables to the manufacturer for automated re-ordering and delivery to the site or mining company. This invention allows for setting the parameters of depletion of consumables that triggers alerts to the various parties to ensure sufficient quantities of consumables are available from a Stand 10 at a mining or construction site.

While embodiments of the invention have been described in the detailed description, the scope of the claims should not be limited by the preferred embodiments set forth in the examples but should be given the broadest interpretation consistent with the description as a whole.

What is claimed is:

1. An industrial consumables storage and detection stand for storing industrial consumables and wirelessly detecting the presence of industrial consumables on the stand and conveying the information on the presence or absence of consumables to a computer or smart device.

2. The use of the stand of claim 1 at a mining site or construction site.

3. A stand for supporting and detecting the presence of one or more industrial consumables each affixed with a radio frequency identification (RFID) tag, said stand comprising:
a. a base frame;
b. a storage rack;
c. a wireless transmitter; and
d. at least one RFID readers.

4. The use of the stand of claim 3 at a mining site or construction site.

5. The stand of claim 3 in which the at least one RFID readers is four RFID readers.

6. A method of determining when industrial consumables need to be replenished in which an Industrial Consumables Storage and Detection Stand stores consumables and wirelessly detects the presence of industrial consumables on the stand and conveys the information on the presence or absence of consumables to one or more computers or smart devices.

7. The method of claim 6 in which the one or more computers or smart devices are located at one or more of an industrial site, industrial company and industrial consumable manufacturer.
